(19) United States
(12) Patent Application Publication
(10) Pub. No.: US 2014/0060334 A1
(43) Pub. Date: Mar. 6, 2014

(54) Air Purifying Device

(71) Applicants: Jackie L. Hearld, Huntington, WV (US); Marcia Lucas, Huntington, WV (US)

(72) Inventors: Jackie L. Hearld, Huntington, WV (US); Marcia Lucas, Huntington, WV (US)

(21) Appl. No.: 14/012,814

(22) Filed: Aug. 28, 2013

Related U.S. Application Data
(60) Provisional application No. 61/694,530, filed on Aug. 29, 2012.

(51) Int. Cl. B01D 50/00

(52) U.S. Cl. CPC B01D 50/004
USPC 96/311

(57) ABSTRACT

An air purification device is provided. In one embodiment, the device is comprised of stainless steel. An ambient air stream is introduced into one end of the device by low-pressure vacuum. After the air stream is introduced, a liquid mist is applied to the air stream. One embodiment employs a series of chambers for moisturizing the air stream with liquid mist, to entrain airborne impurities within moisture droplets. In some embodiments, the moisturized air stream then enters one or more collection chambers, where it undergoes cycles of slower air speed movement and higher air speed movement within one or more cyclonic separators located within one or more collection chambers. The air movement within the one or more cyclonic separators assists in separating the heavier impurity-entrained moisture droplets from the air stream. The purified air stream is then expelled from the device.

### CROSS REFERENCE TO RELATED APPLICATIONS

This application is a utility application which claims priority to U.S. Provisional Application 61/694,530, filed on Aug. 29, 2012. The entire disclosures contained in U.S. Provisional Application 61/694,530, including the attachments thereto, are incorporated herein by reference.

### FIELD OF THE INVENTION

The present application is generally related to air purifying devices that remove particulates and toxins from a stream of air, gas, or liquid. More specifically, the present application relates generally to air purifying devices that entrain airborne impurities within moisture droplets, then use cyclonic air movement to separate impurity-entrained moisture droplets from the air stream.

### BACKGROUND OF THE INVENTION

A large number and variety of industries such as those involved in power production, textile manufacture, petroleum refining, livestock production and many other industries employ operations which involve or include some amount and type of processing or cleaning. Production of so-called “greenhouse gases”, as well as various other toxic emissions commonly associated with industrial plant processes, have long been suspected to contribute in some measure to a host of short term and long term respiratory-related health problems. A non-exhaustive list of environmentally-hazardous industrial activities would include the housing and feeding of livestock, the burning of fossil fuels in coal-fired power plants, and the emission of toxins and particulates through production or use of cleaning products, chemicals, pulp and paper products, petroleum products, paints, hydrocarbons, chemically-treated fabrics, pesticides, and sealants.

In many industries whose operations contribute to environmental pollution, some prior art systems for controlling air quality may seem too complex or ill-suited for a particular facility, thus rendering such prior art systems impractical or cost-prohibitive. For example, prior art systems which only employ the use of air filters may have limited or negligible effect on the removal of noxious gases or very fine particulates from the air. Other systems may require the use of certain chemicals whose properties may render the system hazardous to certain products.

### SUMMARY OF EMBODIMENTS OF THE INVENTION

The device claimed herein has utility in the separation and removal of a variety of airborne impurities from a stream of ambient air. The present device has particular utility in the removal of particulates and pollutants generated through the operation of power plants. However, embodiments can also be directed to the removal of airborne impurities which are produced in a variety of other industries. Therefore, embodiments of the present device are not specifically limited to being utilized in the power production industry.

One of the many further uses for the device is the abatement of ammonia emissions associated with the livestock production industry, where airborne ammonia and dust particles can exist in facilities which house poultry and other livestock, as a result of the breakdown of animal excrement as well as from undigested or unused livestock feed. This may create an unhealthy environment that can ultimately result in a livestock product of less than optimal quality and yield, and may also create an unhealthy environment for persons exposed to such facilities.

In the present embodiment of the air purifying device, a stream of ambient air is pulled into one end of the device and moved through and expelled from another end of the device by the use of vacuum effects. In at least one embodiment, this vacuum effect is generated by one or more fans and/or blowers. In some embodiments, where the targeted impurity is airborne particulates, particles ranging in size from approximately 2.0 micrometers to approximately 10.0 micrometers, the fan or blower may move the air stream into and out of the device at a rate that may range from approximately 1000 cubic feet per minute to approximately 5000 cubic feet per minute.

After the air stream is introduced into the air purifying device, the air stream undergoes a moisturizing process comprised of applying a liquid to the air stream. This liquid emits from one or more misting nozzles located on one or more misting applicators. In at least one embodiment, the misting applicators are comprised of one or more approximately cylindrical pipes located in one or more moisturizing chambers. The air stream moves within and through said one or more moisturizing chambers at a slower speed relative to the speed at which the air stream was initially introduced into the device.

The liquid is applied to the air stream as a mist. The temperature within the moisturizing chamber is maintained below the vaporization point and above the freezing point of the liquid mist. In some embodiments, the liquid mist is comprised of an aqueous solution. In some embodiments, the nature of the mist being applied to the air stream may, depending upon the nature of the impurities sought to be separated from the air stream, be comprised of other than an aqueous solution. The moisturizing of the air stream entraps impurities targeted for removal from the air stream, by forming fine droplets of liquid that entrain the targeted impurities located within the air stream.

In some embodiments, where the targeted impurity is airborne particulates, ranging in size from approximately 2.0 micrometers to approximately 10.0 micrometers, approximately 5 to 10 gallons of aqueous solution may be applied for every approximately 1000 cubic feet of air. Where the targeted impurity is, for example, ammonia gas, approximately 20 to 40 gallons of aqueous solution may be applied for every approximately 1000 cubic feet of air.

As vacuum effects continue to move the moisturized air stream through the air purifying device, the moisturized air stream enters one or more conditioning chambers, whereupon the air stream undergoes a conditioning process. Within said one or more conditioning chambers, the moisturized air stream encounters one or more cyclonic separators. In at least one embodiment of the present device, said conditioning chamber includes four (4) rows of cyclonic separators, with three (3) or more cyclonic separators per row. Other embodiments of the air purifying device may comprise conditioning chambers with more than four rows of cyclonic separators, or more than one but less than four rows of cyclonic separators.

In some embodiments, each of said cyclonic separators is configured in such a manner that said air stream enters said cyclonic separator and swirls within said cyclonic separator, before said air stream exits from said cyclonic separator. In some embodiments, the geometric configuration of one or more of the cyclonic separators may be approximately hexagonal. In other embodiments, the cyclonic separators may be of other geometric configurations.

In one embodiment of the present device, as the moisturized air stream travels through the one or more conditioning chambers, it interacts with the one or more rows of one or more cyclonic separators located within the one or more conditioning chambers. The moisturized air stream which enters said one or more cyclonic separators is made to travel at speeds of higher velocity relative to the stream of air on the outside of said cyclonic separators, and is also made to flow in tight, swirling patterns.

In one embodiment, the impurity-entrained moisture droplets within the air stream are too large to follow said tight, swirling air flow patterns because of the relatively large size of the impurity-entrained moisture droplets. As a result, said impurity-entrained moisture droplets make contact with the walls of the one or more conditioning chambers and/or the walls of said one or more cyclonic separators. This causes said impurity-entrained moisture droplets to collect within the one or more collection chambers and/or within said one or more cyclonic separators, while the remainder of the air stream continues to travel through and beyond the one or more conditioning chambers.

One embodiment of the present device contains three moisturizing chambers and two collection chambers, the arrangement of which is more fully described below. Other embodiments may utilize more than three moisturizing chambers, or they may utilize only one or two moisturizing chambers. Likewise, some embodiments may utilize only one collection chamber, or they may utilize three or more collection chambers.

### BRIEF DESCRIPTION OF THE DRAWINGS

Additional utility and features of this device will become more fully apparent to those skilled in the art by reference to the following drawings, which illustrate some of the primary features of preferred embodiments.

FIG. 1 is a plan view of one side of an embodiment of air purifying device 100 with the various components of the present embodiment of the device identified numerically.

FIG. 2 is a sectional view of collection chamber 105 located within air purifying device 100, within which are contained a series of cyclonic separators 111.

FIG. 3 is a magnified view of a cyclonic separator 111 contained within collection chamber 105.

### DETAILED DESCRIPTION OF EMBODIMENTS OF THE INVENTION

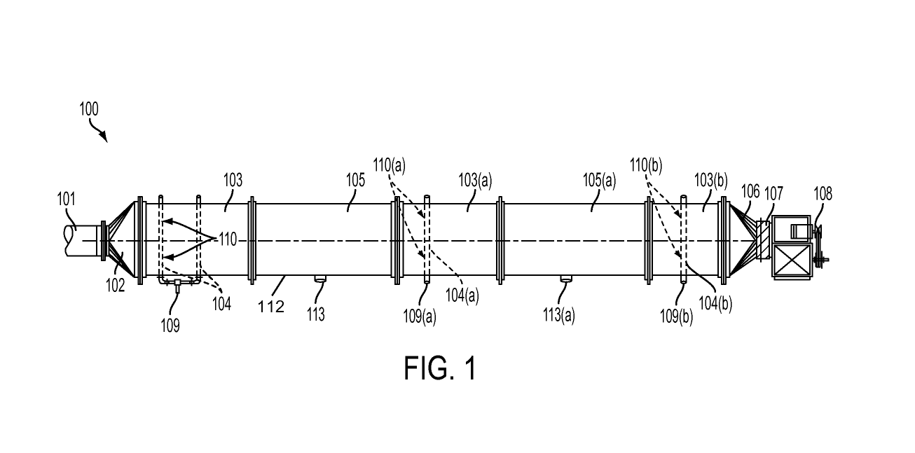

FIG. 1 shows a particular embodiment of the air purifying device 100 which includes the following major components: air intake chamber 101; air deceleration chamber 102; first moisturizing chamber 103; second moisturizing chamber 103(a); third moisturizing chamber 103(b); first liquid intake nozzle 109; second liquid intake nozzle 109(a); third liquid intake nozzle 109(b); first mist applicators 104 with first misting nozzles 110; second mist applicator 104(a) with second misting nozzles 110(a); third mist applicator 104(b) with third misting nozzles 110(b); first collection chamber 105; second collection chamber 105(a); air acceleration chamber 106; blower 107; fan with flex connector 108 and draining ports 113 and 113(a).

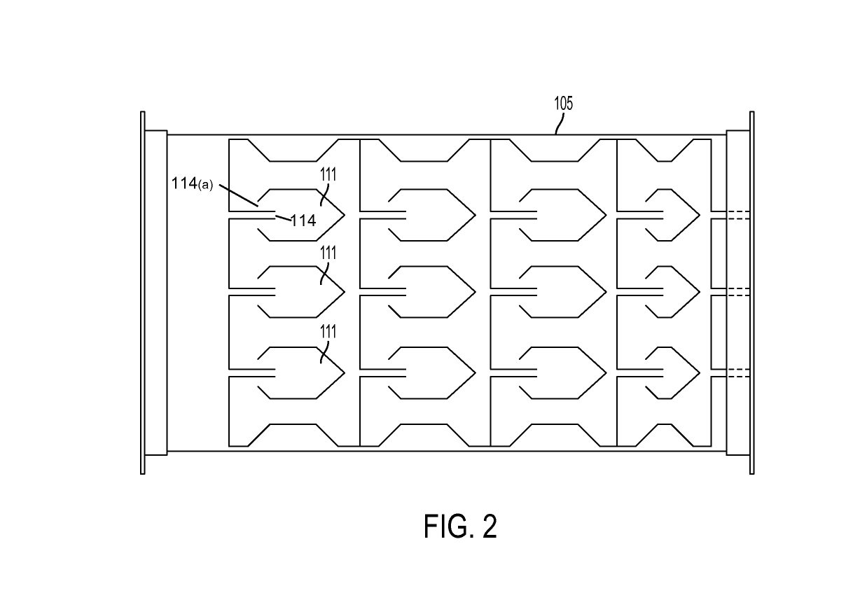

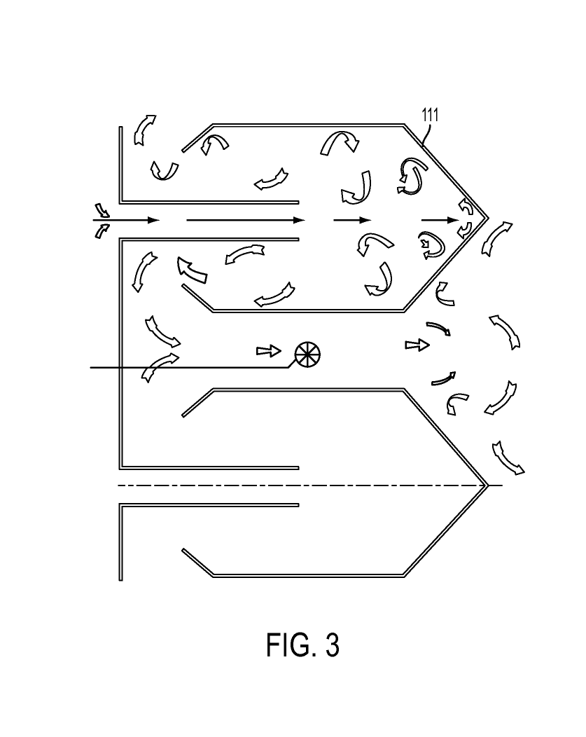

FIG. 2 shows further detail of same embodiment including several rows of cyclonic separators 111 within a typical collection chamber 105. FIG. 3 shows a blow up of a typical cyclonic separator 111, and the drawing features arrows to indicate air flow.

In one embodiment, air purifying device 100 has a total length of approximately twenty one (21) feet, is approximately two (2) feet in width, and is approximately two (2) feet in height, although any or all of these dimensions can be scaled up or down to fit the needed application. The major components of air purifying device 100 can be made of a wide variety of components, and is optimally constructed of stainless steel.

A stream of ambient air enters air intake chamber 101. The ambient air then enters air deceleration chamber 102 where it disperses and transitions to a slower air flow speed before entering first moisturizing chamber 103.

The device of the present application may include one or more purifying steps. In one embodiment, there is a first purifying step and a second purifying step. In said first purifying step, a stream of liquid, which could comprise a compound such as ionized or de-ionized water, is fed into one or more first liquid intake nozzles 109 before entering one or more first mist applicators 104. In at least one embodiment, one or more first misting nozzles 110 are located on each of one or more first mist applicators 104 located within first moisturizing chamber 103. The air stream in first moisturizing chamber 103 is thusly loaded with the liquid that emits as a mist from one or more first misting nozzles 110. The mist loaded into the air stream entrains airborne impurities within droplets of moisture

The moisturized air from first moisturizing chamber 103 then moves into first collection chamber 105, where the moisture-entrained air encounters first cyclonic separators 111. Some embodiments of the present device may comprise one or more rows of one or more cyclonic separators 111. The embodiment in FIG. 2 shows first collection chamber 105 comprised of four (4) rows, with each row comprising at least three (3) first cyclonic separators.

In the embodiment of device 100 depicted, first cyclonic separators 111 are approximately hexagonal in shape, with each of first cyclonic separators 111 having aperture 114 at one end. Aperture 114 serves as the air stream's location of entry into first cyclonic separators 111.

The moisturized air stream enters first cyclonic separators 111 whereupon said air stream transitions to a higher air flow speed. The moisturized air stream within first cyclonic separators 111 moves in a manner that approximates a swirling, cyclonic pattern. Larger particles within the air stream, such as droplets of moisture with particles of dust and/or other impurities entrained within said droplets of moisture, have limited ability to follow the tight swirl of the air stream due to inertia. Said impurity-entrained droplets of moisture strike the walls of first cyclonic separators 111 and/or the walls of first collection chamber 105 before gravity forces the droplets of moisture to collect within one or more first cyclonic separator 111 and/or at bottom 112 of first collection chamber 105, thus purifying the air stream by ridding it of some or all impurities. The purified air stream exits the cyclonic separator 111 via exitways 114(a). Draining port 113 can be used to assist removal of the impurities collected at bottom 112 of collection chamber 105. The departure of the purified air stream from collection chamber 105 concludes the first purifying step.

In one embodiment, a second purifying step follows the first purifying process described above. Said second purifying step commences when the air stream departs first collection chamber 105 and enters into second moisturizing chamber 103(a). Second moisturizing chamber 103(a) contains one or more second mist applicators 104(a). A liquid, which may or may not comprise the same compound as that which was applied to the air stream in first moisturizing chamber 103, is drawn through second liquid intake nozzle 109(a) and into one or more second mist applicators 104(a). One or more second misting nozzles 110(a), attached to one or more second mist applicators 104(a), emits said liquid into the air stream as a mist, thus re-moisturizing the air stream.

The re-moisturized air stream then moves from second moisturizing chamber 103(a) into second collection chamber 105(a), where the re-moisturized air stream encounters second cyclonic separators 111(a). In one embodiment, the number of rows of second cyclonic separators 111(a), the number of second cyclonic separators 111(a) within each row, and the configuration of each second cyclonic separator 111(a) in second collection chamber 105(a), are approximately the same as first cyclonic separators 111 in first collection chamber 105.

As the air stream travels through second collection chamber 105(a), the processes undergone by the air stream are approximately the same as those described in paragraph [0024] through [0026], as the re-moisturized air stream moves within second cyclonic separators 111(a) in a manner which approximates a tight, swirling pattern, and with larger particulates within the re-moisturized air stream, comprising droplets of moisture with particles of dust and other impurities entrained within said droplets, being left behind within said second cyclonic separators 111(a) and/or within said second collection chamber 105(a). Draining port 113(a) can assist removal of impurities collected at bottom 112(a) of collection chamber 105(a). The air stream then departs said second collection chamber 105(a). The departure of the air stream from second collection chamber 105(a) concludes said second purifying step.

Some embodiments of the air purifying device may not include the second purifying step described above, while other embodiments may include three or more purifying steps. Also, the one or more purifying step(s) involved in other embodiments may involve cyclonic separators that may differ from one step to the next in number, as well as in the manner in which they are arranged and/or configured.

In at least one embodiment of the present air purifying device, after the second purifying step, the air stream travels into and through third moisturizing chamber 103(b). While in third moisturizing chamber 103(b), third liquid intake nozzle 109(b) draws a liquid into one or more third mist applicators 104(b). Said liquid is then loaded into the air stream as a mist. Said mist is emitted from one or more third misting nozzles 110(b) attached to said one or more third mist applicators 104(b).

The liquid mist applied to the air stream in third moisturizing chamber 103(b) may or may not be of the same compound which was applied to the air stream in moisturizing chamber 103 and/or second moisturizing chamber 103(a). Also, other embodiments of the air purifying device may not include third moisturizing chamber 103(b).

At this point, the air stream travels into fan acceleration chamber 106. Said air acceleration chamber 106 is approximately funnel-shaped, with a wider end and a narrower end. The air stream enters said air acceleration chamber 106 at said wider end and departs air acceleration chamber 106 at said narrower end. As the air stream travels through air acceleration chamber 106, it transitions from a lower rate of air flow speed to a higher rate of air flow speed. The purified air stream then moves from air acceleration chamber 106 into blower 107. Blower 107 can be adjusted to vary the speed of the air stream from approximately 400 cubic feet per minute (CFM) to approximately 5000 CFM for final exhaust of the purified air stream, although the air stream flow rate can be scaled upward or downward from these rates to fit the application needed. Fan with flex connector 108 serves to pull the purified air stream from out of air purifying device 100.

Overall control of the operational parameters of some embodiments of the air purifying device may be achieved by conventional control techniques. For example, the power supply may comprise a 200 Ampere, 240 Volt AC power supply which can be situated in any number of locations along air purifying device 100. Some embodiments of the device may also utilize electric heaters with varister-type temperature control mechanisms in the air stream purifying process, depending upon the nature of the targeted impurity.

What is claimed is:

1. An air purifying device for removing impurities from a stream of air, comprising:
an elongate housing comprised of corrosion-resistant metal, and having a three-dimensional configuration which approximates an elongate rectangular box;
said housing having an air flow path within, along which a stream of air flows from an upstream position to a downstream position;
said housing having an air intake chamber in proximity to an upstream position of said stream of air, through which said stream of air enters into said housing;
an air purifying zone disposed within said housing along a midstream position of said stream of air, said air purifying zone comprising of an air stream deceleration chamber, one or more air purifying cycles, a final moisturizing chamber, and an air stream acceleration chamber;
said housing having an expulsion chamber in proximity to a downstream position of said stream of air, from which said stream of air exits said housing.

2. The air purifying device of claim 1, wherein:
said stream of air introduced into said air intake chamber is ambient air; and
said stream of air exiting said expulsion chamber is purified air.

3. The air purifying device of claim 1, wherein:
said air flow path comprises induction of said stream of air into said air intake chamber, traversing of said stream of air from said air intake chamber into said air purifying zone, traversing of said stream of air from said air purifying zone into said expulsion chamber, and impulsion of said stream of air from said expulsion chamber.

4. The air purifying device of claim 3, wherein;
Impulsion of said air flow path occurs via an air flow-directing element disposed along said expulsion chamber.

5. The air purifying device of claim 4, wherein:
said air flow-directing element comprises any one from the group consisting of a blower, an exhaust fan, and an air recirculation device.

6. The air purifying device of claim 1, wherein:
said air deceleration chamber has a generally funnel-shaped inside surface within which said stream of air decelerates as it traverses from an area of minimum dimension to an area of maximum dimension of said air deceleration chamber.

7. The air purifying device of claim 1, wherein;
each of said air purifying cycles comprises said stream of air traversing a misting chamber, then traversing a collection chamber.

8. The air purifying device of claim 7, wherein;
said misting chamber has one or more hollow, elongate, cylindrical spray arms disposed within it.

9. The air purifying device of claim 8, wherein;
each of said one or more cylindrical spray arms comprises corrosion-resistant metal and has a plurality of apertures disposed thereon.

10. The air purifying device of claim 9, wherein;
liquid mist emits from said plurality of apertures to moisturize said stream of air and entrain impurities located within said stream of air.

11. The air purifying device of claim 10, wherein:
each of said one or more cylindrical spray arms has one end connected to a liquid supply source.

12. The air purifying device of claim 7, wherein:
said collection chamber has a plurality of cyclonic separators disposed within it.

13. The air purifying device of claim 12, wherein:
each of a plurality of cyclonic separators has an inner region and a single aperture positioned substantially to meet said air flow path and temporarily trap said moisturized stream of air within said inner region.

14. The air purifying device of claim 13, wherein:
configuration of said inner region creates increased velocity of said trapped moisturized stream of air, relative to the velocity of said moisturized stream of air not trapped within said inner region.

15. The air purifying device of claim 14, wherein:
impurity-entrained moisture separates from said trapped moisturized stream of air via centrifugal forces causing relatively heavier impurity-entrained moisture within said trapped moisturized stream of air to be thrown against walls of said inner area.

16. The collection chamber of claim 12, further comprising:
at least one liquid drain portal disposed along a bottom portion of said collection chamber.

17. The air purifying device of claim 16, wherein:
gravity facilitates draining of said impurity-entrained moisture from said housing via said liquid drain portal.

18. The air purifying zone of claim 3, wherein:
said final moisturizing chamber has one or more hollow, elongate, approximately cylindrical spray arms;
each of said cylindrical spray arms being comprised of corrosion-resistant metal and having a plurality of apertures disposed thereon;
said stream of air being moisturized via emission of liquid mist from said plurality of apertures;
each of said cylindrical spray arms having one end connected to a liquid supply source; and
said air stream acceleration chamber having a generally funnel-shaped inside surface within which said stream of air accelerates as it traverses from an area of maximum dimension to an area of minimum dimension of said air stream acceleration chamber.
